(19) United States
(12) Patent Application Publication
(10) Pub. No.: US 2006/0239651 A1
(43) Pub. Date: Oct. 26, 2006

(54) Portable multimedia platform

(75) Inventors: Chia-Ling Chang, Sindian City (TW); Ming-Xia Yang, Sindian City (TW); Yao-Hui Yeh, Sindian City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: AboCom Systems, Inc.

(21) Appl. No.: 11/102,972

(22) Filed: Apr. 11, 2005

(51) Int. Cl. H04N 7/00

(52) U.S. Cl. 386/96

(57) ABSTRACT

The present invention discloses a multimedia platform integrating with different interfaces. The multimedia platform comprises a portable multimedia player as a host. A connect interface is electrically connected with the portable multimedia player. A video interface and an audio interface are electrically connected with the portable multimedia player.

### FIELD OF THE INVENTION

The present invention relates to a multimedia platform, and more specially, to a portable multimedia platform integrating with different interfaces, wherein the portable multimedia player as a host may be electrically connected with a connect interface to transmit or play an audio or video data through an audio or video interface.

### DESCRIPTION OF RELATED ART

Electronic products marketing has been developed the related applications. The applications comprise, for example, a digital compressed processed multimedia disc, wherein audio data format comprises MP3, WAVE, WMV, ACPCM etc. and video data format comprises JEPG, AVI, WVF, MPEG1, MPEG2, MPEG4 etc. Besides, replacement cycle of the electronic products is gradually reduced. The applications and performance of the electronic products need to be promoted and diversified to meet the requirement of marketing, thereby creating a portable player.

The known multimedia player comprises a portable radio, audio device, LCD TV, DVD player, CD player, MP3 player, mobile storage device etc. The advantages of the portable player is portable and convenient, but disadvantage is that the playing data format of related products is confined and specialized.

Moreover, a general CD player can only play audio data format. VCD and DVD player can be compatible with different audio data format, but the above type products are generally having a LCD display and using a disc to store data, therefore its volume is large.

Capacity of a flash memory has been rapidly enlarged with semiconductor technique developed. The volume of various memory cards and flash memory is smaller than volume of the disc. In spite of Bluetooth earphone, wireless speaker, the known playing devices are still confined using in special environments and traditional equipments.

In view of the aforesaid problems of the prior art, it is an object of this invention to provide a portable multimedia platform to satisfy the requirement of different users.

### SUMMARY OF THE INVENTION

The object of the present invention is to disclose a portable multimedia platform integrating with different interfaces. The portable multimedia player and host may be electrically connected with a connect interface to transmit or play an audio or video data through an audio or video interface.

The present invention discloses a multimedia platform made by integrating with different interfaces. The multimedia platform comprises a portable multimedia player and host. A connect interface is coupled to the portable multimedia player to be a media of connecting with different interfaces. A control interface is coupled to the connect interface, wherein user's input command may be transmitted to the portable multimedia player through the connect interface. A video interface is coupled to the connect interface. The portable multimedia player may transmit the audio and video data to an outside player by means of the video interface through the connect interface to play the audio and video data. An audio interface is coupled to the connect interface. The portable multimedia player may transmit the audio data to an outside player by means of the audio interface through the connect interface to play the audio data.

The portable multimedia player and host of the present invention comprises a central processor unit (CPU). An input/output (I/O) interface is coupled to the central processor unit (CPU) to be a media between the portable multimedia player and the connect interface. A control interface is coupled to the central processor unit (CPU), wherein the control interface is capable of controlling operations of the portable multimedia player through the central processor unit (CPU). A memory is coupled to the central processor unit (CPU) to store data. A hard discs device (HDD) is coupled to the central processor unit (CPU) to store the audio and video data. A LCD display is coupled to the central processor unit (CPU) to display some functional information and image. An audio device is coupled to the central processor unit (CPU) to play the audio data stored in the hard discs device (HDD).

These and other features of the present invention and advantages will be more clearly understood from the drawings and description of a preferred embodiment.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates an example of a multimedia platform according to the present invention.

FIG. 2 illustrates an example of a multimedia platform player and host according to the present invention.

### DETAILED DESCRIPTION OF THE INVENTION

In the following description, numerous specific details are provided, such as the identification of various system components, to provide a thorough understanding of embodiments of the invention. However, one skilled in the art will recognize that the invention can be practiced without one or more of the specific details, or with other methods, components, materials, etc. In still other instances, well-known structures, materials, or operations are not shown or described in detail to avoid obscuring aspects of various embodiments of the invention.

The multimedia platform 10 of the present invention comprises a portable multimedia player as a host, a connect interface, a control interface, a video interface and an audio interface. The multimedia platform 10 may provide a user to use the above player and interfaces in different environments. The multimedia platform 10 is compatible with the traditional equipments.

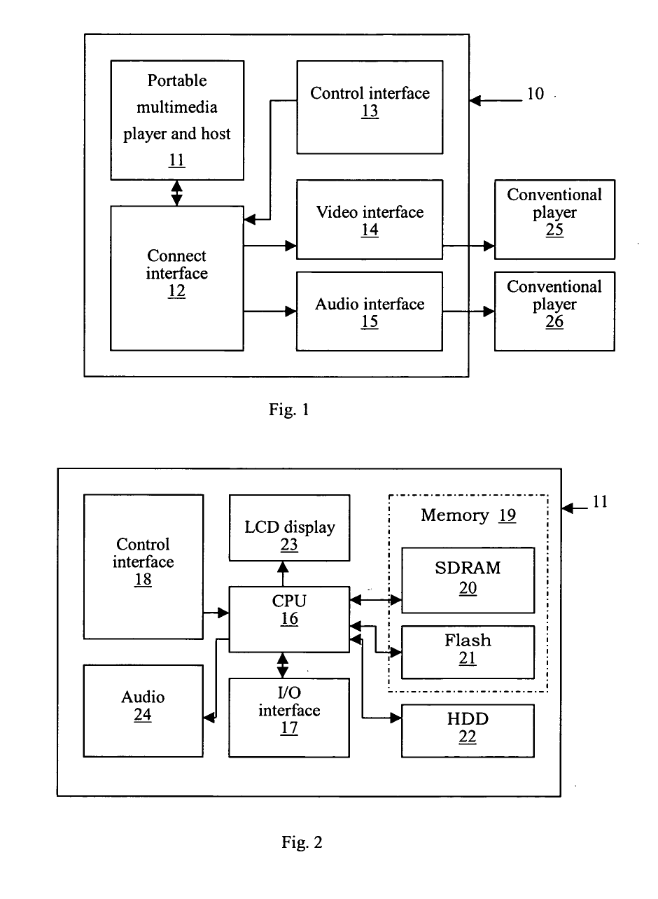

As shown in FIG. 1, the multimedia platform 10 comprises a portable multimedia player 11. In one embodiment, the portable multimedia player 11 may be loaded or un-loaded from the multimedia platform 10. A connect interface 12 is coupled to the portable multimedia player 11 to be a media of connecting with different interfaces. A control interface 13 is coupled to the connect interface 12, wherein user's input command may be transmitted to the portable multimedia player 11 through the connect interface 12. A video interface 14 is coupled to the connect interface 12. The portable multimedia player 11 may transmit the audio and video data by means of the video interface 14. In other words, a traditional player 25 may play the audio and video data output by the portable multimedia player 11 through the video interface 14. An audio interface 15 is coupled to the connect interface 12. Similarly, the portable multimedia player 11 may be output the audio data through the audio interface 15. In other words, a traditional player 26 may play the audio data outputted by the portable multimedia player 11 through the audio interface 15.

In one embodiment, the connect interface 12 comprises a wire or wireless connect interface. The wire connect interface comprises but not limited to an USB or an IEEE-1934. The protocol of the wireless connect interface comprises but not limited to a protocol used in RF technology connect, such as Bluetooth, 802.11a, 802.11b or 802.11g.

In one embodiment, the control interface 13 comprises but not limited to a remote control IrDA, RF or contact control. The video interface 14 comprises but not limited to a D-sub, S-video, DVI or RCA terminal. The audio interface 15 comprises but not limited to a stereo audio output or a stereo microphone input.

Please refer to FIG. 2, the portable multimedia player and the host 11 of the present invention comprises a central processor unit (CPU) 16. An input/output (I/O) interface 17 is coupled to the central processor unit (CPU) 16 and the connect interface 12 to be a media between the portable multimedia player 11 and the connect interface 12, thereby inputting or outputting an audio and video data through said input/output (I/O) interface 17. The protocol of the input/output (I/O) interface 17 comprises a protocol used in Bluetooth 802.11a 802.11b or 802.11g. A control interface 18 is coupled to the central processor unit (CPU) 16, wherein the user's input command is capable of controlling operations of the portable multimedia player 11 through the central processor unit (CPU) 16. User's input command input by the control interface 13 of FIG. 1 may be transmitted to the central processor unit (CPU) 16 through the input/output (I/O) interface 17 to execute the requirement.

A memory 19 is coupled to the central processor unit (CPU) 16. The memory 19 comprises but not limited to a SDRAM 20 and a flash memory 21. The SDRAM 20 is a database to store audio and video data and the flash memory 21 is provided to store operating programs. A hard discs device (HDD) 22 is coupled to the central processor unit (CPU) 16 to store the audio and video data. A LCD display 23 is coupled to the central processor unit (CPU) 16 to display some functional information and image, such as media playing title, files volume, playing contents to select and transmit the stored audio and video catalogue data. The portable multimedia player 11 of the present invention can directly play the audio and video data stored the hard discs device (HDD) 22 through the LCD display 23 or audio device 24. The portable multimedia player 11 of the present invention may simultaneously have a portable hard discs device (HDD) function to accomplish all data backup and store. The portable multimedia player 11 of the present invention may be used in different environments, such as an office, home or vehicle.

While the invention is described and illustrated here in the context of a limited number of embodiments, the invention may be embodied in many forms without departing from the spirit of the essential characteristics of the invention. The illustrated and described embodiments are therefore to be considered in all respects as illustrative and not restrictive. Thus, the scope of the invention is indicated by the appended claims rather than by the foregoing description, and all changes which come within the meaning and range of equivalency of the claims are intended to be embraced therein.

What is claimed is:

1. A multimedia platform, comprising:
a portable multimedia player;
a connect interface coupled to said portable multimedia player;
a control interface coupled to said connect interface, said control interface controlling said portable multimedia player through said connect interface;
a video interface coupled to said connect interface, wherein said portable multimedia player is capable of transmitting an audio and video data through said video interface; and
an audio interface coupled to said connect interface, wherein said portable multimedia player is capable of transmitting an audio data through said audio interface.

2. The multimedia platform according to claim 1, wherein said portable multimedia player comprises;
a central processor unit (CPU);
an input/output (I/O) interface coupled to said central processor unit (CPU) and said connect interface, thereby inputting or outputting an audio and video data through said input/output (I/O ) interface;
a second control interface coupled to said central processor unit (CPU), wherein said second control interface is capable of controlling operations of said portable multimedia player through said central processor unit (CPU);
a memory coupled to said central processor unit (CPU) to store data;
a hard discs device (HDD) coupled to said central processor unit (CPU) to store said audio and video data;
a LCD display coupled to said central processor unit (CPU) to display some functional information and image; and
an audio device coupled to said central processor unit (CPU).

3. The multimedia platform according to claim 2, wherein said memory comprises a SDRAM and a flash memory.

4. The multimedia platform according to claim 3, wherein said SDRAM is provided to store multimedia data and said flash is provided to store operating programs.

5. The multimedia platform according to claim 1, wherein said connect interface comprises a wire connect interface.

6. The multimedia platform according to claim 5, wherein said wire connect interface comprises an USB or an IEEE-1934.

7. The multimedia platform according to claim 1, wherein said connect interface comprises a wireless connect interface.

8. The multimedia platform according to claim 7, wherein a protocol of said wireless connect interface comprises a protocol used in Bluetooth, 802.11a, 802.11b or 802.11 g.

9. The multimedia platform according to claim 1, wherein said control interface comprises a remote control IrDA, RF or contact control.

10. The multimedia platform according to claim 1, wherein said video interface comprises a D-sub, S-video, DVI or RCA terminal.

11. The multimedia platform according to claim 1, wherein said audio interface comprises a stereo audio output or a stereo microphone input.

12. The multimedia platform according to claim 2, wherein a protocol of said input/output (I/O) interface comprises a protocol used in Bluetooth 802.11a 802.11b or 802.1g.
